(19) United States
(12) Patent Application Publication
(10) Pub. No.: US 2024/0072960 A1
(43) Pub. Date: Feb. 29, 2024

(54) FLEXIBLE RESOURCE CONFIGURATION FOR WIRELESS COMMUNICATION

(71) Applicant: Lenovo (Singapore) Pte. Ltd., New Tech Park (SG)

(72) Inventors: Majid Ghanbarinejad, Chicago, IL (US); Vijay Nangia, Woodridge, IL (US); Hyejung Jung, Northbrook, IL (US)

(21) Appl. No.: 18/260,580

(22) PCT Filed: Jan. 10, 2022
(86) PCT No.: PCT/IB2022/050153

§ 371 Date: Jul. 6, 2023

Related U.S. Application Data
(60) Provisional application No. 63/135,468, filed on Jan. 8, 2021.

(51) Int. Cl. H04L 5/00

(52) U.S. Cl. CPC H04L 5/0048

(57) ABSTRACT

Apparatuses, methods, and systems are disclosed for flexible resource configuration for wireless communication. One method includes receiving a first configuration of a first reference signal; receiving a second configuration of a second reference signal; and receiving a third configuration including a first indication of a set of flexible resources, a first association with the first reference signal, and a second association with the second reference signal. The method includes determining whether a resource in the set of flexible resources is to be used for a downlink communication and/or an uplink communication. The method includes, if the resource is to be used for the downlink communication, transmitting the first reference signal according to the first configuration; and, if the resource will be used for the uplink communication, transmitting the second reference signal according to the second configuration.

### CROSS-REFERENCE TO RELATED APPLICATIONS

This application claims priority to U.S. Patent Application Ser. No. 63/135,468 entitled “APPARATUSES, METHODS, AND SYSTEMS FOR INTER-DONOR COORDINATION IN INTEGRATED ACCESS AND BACKHAUL” and filed on Jan. 8, 2021 for Majid Ghanbarinejad, which is incorporated herein by reference in its entirety.

### FIELD

The subject matter disclosed herein relates generally to wireless communications and more particularly relates to flexible resource configuration for wireless communication.

### BACKGROUND

In certain wireless communications networks, resources may be assigned for communication. In such networks, resource assignment may be inefficient.

### BRIEF SUMMARY

Methods for flexible resource configuration for wireless communication are disclosed. Apparatuses and systems also perform the functions of the methods. One embodiment of a method includes receiving, at a wireless node, a first configuration of a first reference signal. In some embodiments, the method includes receiving a second configuration of a second reference signal. In certain embodiments, the method includes receiving a third configuration including a first indication of a set of flexible resources, a first association with the first reference signal, and a second association with the second reference signal. In various embodiments, the method includes determining whether a resource in the set of flexible resources is to be used for a downlink communication, an uplink communication, or a combination thereof. In some embodiments, the method includes, in response to determining that the resource in the set of flexible resources is to be used for the downlink communication, transmitting the first reference signal according to the first configuration. In certain embodiments, the method includes, in response to determining that the resource in the set of flexible resources will be used for the uplink communication, transmitting the second reference signal according to the second configuration.

One apparatus for flexible resource configuration for wireless communication includes a wireless node. In some embodiments, the apparatus includes a receiver that: receives a first configuration of a first reference signal; receives a second configuration of a second reference signal; and receives a third configuration including a first indication of a set of flexible resources, a first association with the first reference signal, and a second association with the second reference signal. In various embodiments, the apparatus includes a processor that determines whether a resource in the set of flexible resources is to be used for a downlink communication, an uplink communication, or a combination thereof. In certain embodiments, the apparatus includes a transmitter that: in response to determining that the resource in the set of flexible resources is to be used for the downlink communication, transmits the first reference signal according to the first configuration; and, in response to determining that the resource in the set of flexible resources will be used for the uplink communication, transmits the second reference signal according to the second configuration.

Another embodiment of a method for flexible resource configuration for wireless communication includes transmitting, from a wireless entity over an F1 interface, a configuration comprising information indicating a set of soft resources. In some embodiments, the method includes transmitting, over an Xn interface, the configuration including the information indicating the set of soft resources. In certain embodiments, the method includes receiving, over the F1 interface, information of at least one availability indication (AI) message. Each AI message of the at least one AI message is associated with at least one soft resource in the set of soft resources. In various embodiments, the method includes computing an AI parameter as a function of the at least one AI message. In some embodiments, the method includes transmitting, over the Xn interface, an information element including the AI parameter.

Another apparatus for flexible resource configuration for wireless communication includes a wireless entity. In some embodiments, the apparatus includes a transmitter that: transmits, over an F1 interface, a configuration including information indicating a set of soft resources; and transmits, over an Xn interface, the configuration including the information indicating the set of soft resources. In various embodiments, the apparatus includes a receiver that receives, over the F1 interface, information of at least one availability indication (AI) message. Each AI message of the at least one AI message is associated with at least one soft resource in the set of soft resources. In certain embodiments, the apparatus includes a processor that computes an AI parameter as a function of the at least one AI message. The transmitter transmits, over the Xn interface, an information element including the AI parameter.

A further embodiment of a method for flexible resource configuration for wireless communication includes receiving, by a wireless entity over an Xn interface, a configuration including information indicating a set of soft resources associated with at least one integrated access and backhaul node. In some embodiments, the method includes receiving, over the Xn interface, location information associated with the at least one integrated access and backhaul node. In certain embodiments, the method includes transmitting, over an F1 interface, the configuration including information indicating the set of soft resources. A destination of the transmission is determined based on the location information.

A further apparatus for flexible resource configuration for wireless communication includes a wireless entity. In some embodiments, the apparatus includes a receiver that: receives, over an Xn interface, a configuration including information indicating a set of soft resources associated with at least one integrated access and backhaul node; and receives, over the Xn interface, location information associated with the at least one integrated access and backhaul node. In various embodiments, the apparatus includes a transmitter that transmits, over an F1 interface, the configuration including information indicating the set of soft resources. A destination of the transmission is determined based on the location information.

Yet another embodiment of a method for flexible resource configuration for wireless communication includes receiving, at a wireless entity over an Xn interface, a set of soft resources associated with at least one integrated access and backhaul node. In some embodiments, the method includes receiving, over the Xn interface, location information associated with the at least one integrated access and backhaul node. In certain embodiments, the method includes transmitting, over an F1 interface, the information of availability indication (AI) messages. A destination of the transmission is determined based on the location information.

Yet another apparatus for flexible resource configuration for wireless communication includes a wireless entity. In some embodiments, the apparatus includes a receiver that: receives, over an Xn interface, a set of soft resources associated with at least one integrated access and backhaul node; and receives, over the Xn interface, location information associated with the at least one integrated access and backhaul node. In various embodiments, the apparatus includes a transmitter that transmits, over an F1 interface, the information of availability indication (AI) messages. A destination of the transmission is determined based on the location information.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for flexible resource configuration for wireless communication;

FIG. 2 is a schematic block diagram illustrating one embodiment of an apparatus that may be used for flexible resource configuration for wireless communication;

FIG. 3 is a schematic block diagram illustrating one embodiment of an apparatus that may be used for flexible resource configuration for wireless communication;

FIG. 4 is a schematic block diagram illustrating one embodiment of a system having variable inter-cell interference from an IAB system to a legacy cell;

FIG. 5 is a schematic block diagram illustrating one embodiment of a system showing a timeline and association between reference signals and flexible resources;

FIGS. 6 through 8 are schematic block diagrams illustrating embodiments of systems showing a timeline and association between reference signals and flexible resources for time domain multiplexing;

FIGS. 9 through 11 are schematic block diagrams illustrating embodiments of systems showing a timeline and association between reference signals and flexible resources for frequency domain multiplexing and/or frequency domain multiplexing combined with time domain multiplexing;

FIGS. 12 through 14 are schematic block diagrams illustrating embodiments of systems showing a timeline and association between reference signals and flexible resources for spatial domain multiplexing and/or frequency domain multiplexing;

FIG. 15 is a flow chart diagram illustrating one embodiment of a method for flexible resource configuration for wireless communication;

FIG. 16 is a flow chart diagram illustrating another embodiment of a method for flexible resource configuration for wireless communication;

FIG. 17 is a flow chart diagram illustrating a further embodiment of a method for flexible resource configuration for wireless communication; and

FIG. 18 is a flow chart diagram illustrating yet another embodiment of a method for flexible resource configuration for wireless communication.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures Like numbers refer to like elements in all figures, including alternate embodiments of like elements.

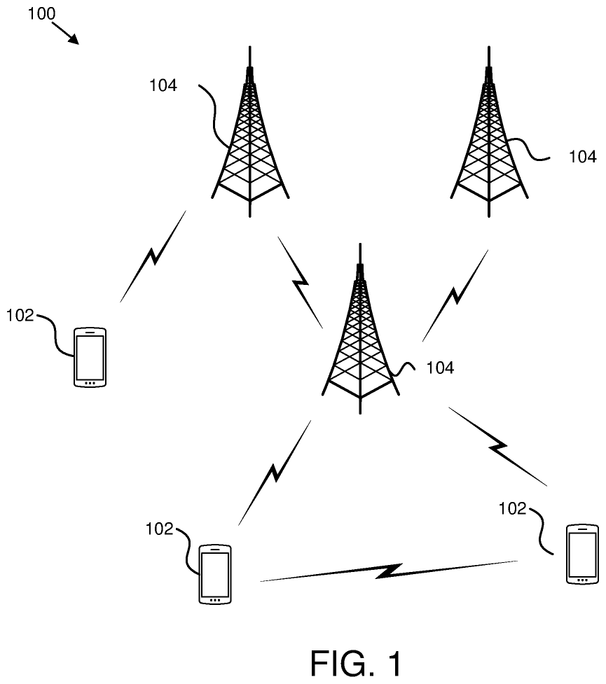

FIG. 1 depicts an embodiment of a wireless communication system 100 for flexible resource configuration for wireless communication. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, at a wireless node, a first configuration of a first reference signal. In some embodiments, the network unit 104 may receive a second configuration of a second reference signal. In certain embodiments, the network unit 104 may receive a third configuration including a first indication of a set of flexible resources, a first association with the first reference signal, and a second association with the second reference signal. In various embodiments, the network unit 104 may determine whether a resource in the set of flexible resources is to be used for a downlink communication, an uplink communication, or a combination thereof. In some embodiments, the network unit 104 may, in response to determining that the resource in the set of flexible resources is to be used for the downlink communication, transmit the first reference signal according to the first configuration. In certain embodiments, the network unit 104 may, in response to determining that the resource in the set of flexible resources will be used for the uplink communication, transmit the second reference signal according to the second configuration. Accordingly, the network unit 104 may be used for flexible resource configuration for wireless communication.

In certain embodiments, a network unit 104 may transmit, from a wireless entity over an F1 interface, a configuration comprising information indicating a set of soft resources. In some embodiments, the network unit 104 may transmit, over an Xn interface, the configuration including the information indicating the set of soft resources. In certain embodiments, the network unit 104 may receive, over the F1 interface, information of at least one availability indication (AI) message. Each AI message of the at least one AI message is associated with at least one soft resource in the set of soft resources. In various embodiments, the network unit 104 may compute an AI parameter as a function of the at least one AI message. In some embodiments, the network unit 104 may transmit, over the Xn interface, an information element including the AI parameter. Accordingly, the network unit 104 may be used for flexible resource configuration for wireless communication.

In various embodiments, a network unit 104 may receive, by a wireless entity over an Xn interface, a configuration including information indicating a set of soft resources associated with at least one integrated access and backhaul node. In some embodiments, the network unit 104 may receive, over the Xn interface, location information associated with the at least one integrated access and backhaul node. In certain embodiments, the network unit 104 may transmit, over an F1 interface, the configuration including information indicating the set of soft resources. A destination of the transmission is determined based on the location information. Accordingly, the network unit 104 may be used for flexible resource configuration for wireless communication.

In certain embodiments, a network unit 104 may receive, at a wireless entity over an Xn interface, a set of soft resources associated with at least one integrated access and backhaul node. In some embodiments, the network unit 104 may receive, over the Xn interface, location information associated with the at least one integrated access and backhaul node. In certain embodiments, the network unit 104 may transmit, over an F1 interface, the information of availability indication (AI) messages. A destination of the transmission is determined based on the location information. Accordingly, the network unit 104 may be used for flexible resource configuration for wireless communication.

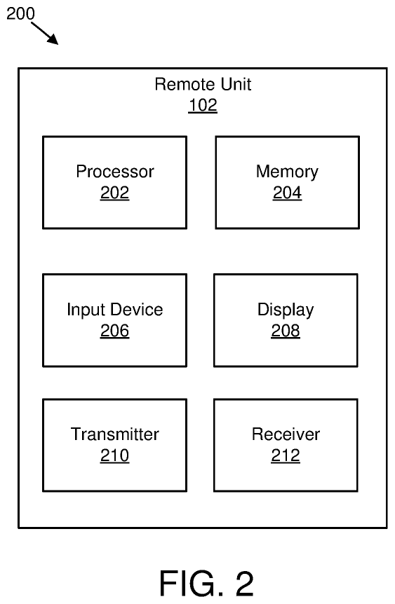

FIG. 2 depicts one embodiment of an apparatus 200 that may be used for flexible resource configuration for wireless communication. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

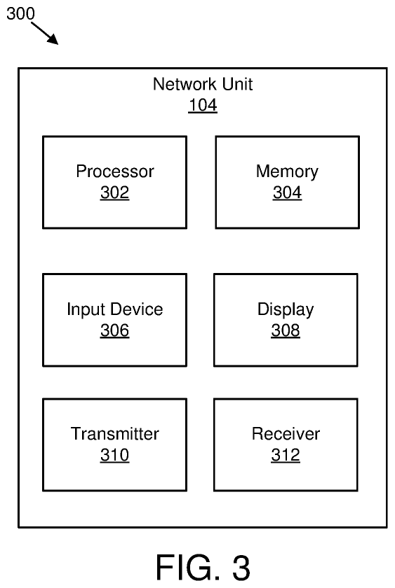

FIG. 3 depicts one embodiment of an apparatus 300 that may be used for flexible resource configuration for wireless communication. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312: receives a first configuration of a first reference signal; receives a second configuration of a second reference signal; and receives a third configuration including a first indication of a set of flexible resources, a first association with the first reference signal, and a second association with the second reference signal. In various embodiments, the processor 302 determines whether a resource in the set of flexible resources is to be used for a downlink communication, an uplink communication, or a combination thereof. In certain embodiments, the transmitter 310: in response to determining that the resource in the set of flexible resources is to be used for the downlink communication, transmits the first reference signal according to the first configuration; and, in response to determining that the resource in the set of flexible resources will be used for the uplink communication, transmits the second reference signal according to the second configuration.

In some embodiments, the transmitter 310: transmits, over an F1 interface, a configuration including information indicating a set of soft resources; and transmits, over an Xn interface, the configuration including the information indicating the set of soft resources. In various embodiments, the receiver 312 receives, over the F1 interface, information of at least one availability indication (AI) message. Each AI message of the at least one AI message is associated with at least one soft resource in the set of soft resources. In certain embodiments, the processor 302 computes an AI parameter as a function of the at least one AI message. The transmitter transmits, over the Xn interface, an information element including the AI parameter.

In certain embodiments, the transmitter 310 may receiver 312: receives, over an Xn interface, a configuration including information indicating a set of soft resources associated with at least one integrated access and backhaul node; and receives, over the Xn interface, location information associated with the at least one integrated access and backhaul node. In various embodiments, the transmitter 310 transmits, over an F1 interface, the configuration including information indicating the set of soft resources. A destination of the transmission is determined based on the location information.

In some embodiments, the receiver 312: receives, over an Xn interface, a set of soft resources associated with at least one integrated access and backhaul node; and receives, over the Xn interface, location information associated with the at least one integrated access and backhaul node. In various embodiments, the transmitter 310 transmits, over an F1 interface, the information of availability indication (AI) messages. A destination of the transmission is determined based on the location information.

In certain embodiments, integrated access and backhaul (“IAB”) may be used for new radio access technology (“NR”) (e.g., release 16 (“Rel-16”)). The IAB technology may aim at increasing deployment flexibility and reducing fifth generation (“5G”) rollout costs. It may enable service providers to reduce cell planning and spectrum planning efforts while using the wireless backhaul technology.

In some embodiments, although an IAB specification is not limited to a specific multiplexing and duplexing scheme, a focus may be on time-division multiplexing (“TDM”) between upstream communications (e.g., with a parent IAB node or IAB donor) and downstream communications (with a child IAB node or a user equipment (“UE”)).

In various embodiments, interference management may be enhanced to facilitate multiplexing between communications with parent and child IAB nodes. Interference may include self-interference (“SI”) (e.g., interference from one antenna panel to another antenna panel) and cross-link interference (“CLI”) (e.g., interference from one parent-child pair to another parent-child pair). CLI and remote interference management (“RIM”) may be taken as a starting point for interference management in enhanced IAB systems.

In certain embodiments, such as in time-division duplexing (“TDD”) systems, a base station (e.g., a gNB) may inform its neighboring cells of its intended TDD downlink (“DL”) and uplink (“UL”) (“DL-UL”) configuration. This may assist adjacent cells in interference management by allowing them to communicate information of potential interference on an Xn interface rather than merely performing over-the-air (“OTA”) interference measurements. However, this may only be well suited for legacy systems where interference from a neighboring base station is caused by transmissions from one transmit-receive point (“TRP”) or other closely located TRPs. In an IAB system, IAB distributed units (“DUs”) (“IAB-DUs”) connected to an IAB central unit (“CU”) (“IAB-CU”) may be scattered in a large geographical area, hence causing very different levels of interference. Furthermore, mobility and beam management at high frequencies such as frequency range 2 (“FR2”) may exacerbate a problem.

A problem of interference coordination in IAB systems may be at least partially resolved with various embodiments described herein.

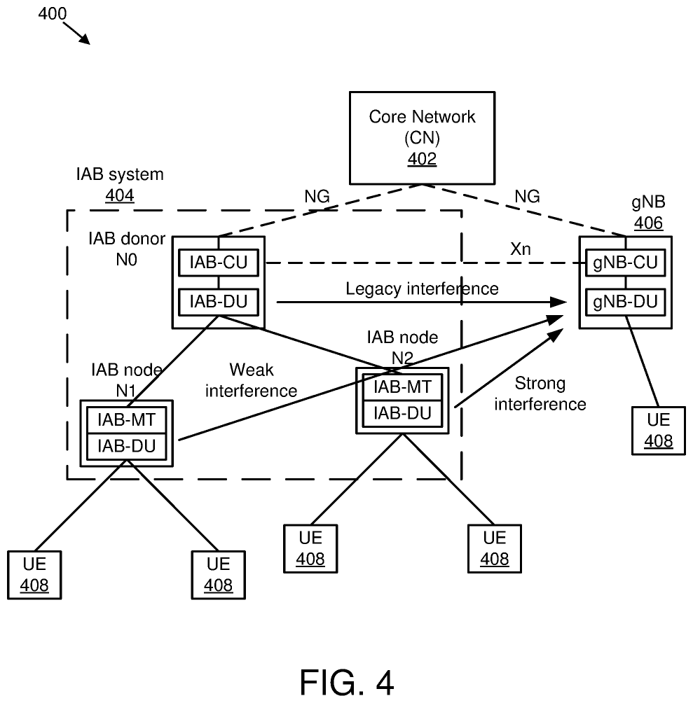

FIG. 4 is a schematic block diagram illustrating one embodiment of a system 400 having variable inter-cell interference from an IAB system to a legacy cell. The system 400 includes a core network (“CN”) 402, an IAB system 404, a legacy base station (e.g., gNode B, gNB) 406, and UEs 408. The IAB system 404 and the legacy base station 406 are connected to the CN 402 through NG interfaces. Centralized units of the two entities may also be connected through an Xn interface.

If the IAB system 404 were only the IAB donor NO, the interference from the IAB-DU of the IAB donor on the gNB-DU would be only legacy interference (e.g., interference that would be experienced by a gNB from another gNB). This interference may be mitigated by conventional methods such as proper cell planning (e.g., in the case of fixed gNBs), interference coordination such as by signaling on Xn, and so forth. However, in the case of the IAB system 404, possibly with multiple IAB nodes connected to one IAB donor through one or multiple hops, and possibly with mobile IAB nodes, the interference is not all legacy interference. If an IAB node is and/or gets close to the gNB 406, the interference may be stronger than the legacy interference, which may require stricter interference management. If an IAB node is and/or gets farther from the gNB 406, the interference may be weaker than the legacy interference, or essentially negligible, hence requiring little or no attention by the gNB 406.

In certain embodiments, a current Xn application protocol (“XnAP”) signaling enables gNBs (and by extension, IAB donors) to exchange information on their TDD configurations. This may help other gNBs to handle the interference where it is expected based on information. However, this information may not capture a variety of interference introduced by an IAB system compared to a legacy gNB. In some embodiments: 1) an IAB system is geographically distributed, possibly through multiple hops in a wide area—each node may cause a very different interference on a certain victim gNB; 2) in an IAB system, IAB nodes are configured with dedicated TDD configurations that may or may not override common TDD configurations; 3) an IAB uses a wide variety of configurations including flexible and soft resources to increase flexibility in resource management—this may contribute to interference variations during operation; and/or 4) beamforming may introduce further variation in interference introduced by an IAB node.

In some embodiments, a problem may be based on an example with an IAB system and an NR base station (e.g., gNB); however, embodiments herein may be applicable to a variety of scenarios including multiple IAB systems, gNBs, eNBs (e.g., base stations of other standards), eLTE eNBs, ng-eNBs, en-gNBs, and so forth.

In various embodiments, there may be a scenario where an aggressor is an IAB donor NO, and a victim is a gNB. Extension to other types of victim nodes such as IAB donors, IAB nodes, or other types of base stations, TRPs, relay nodes, access points, and so forth may be made.

A first set of embodiments may include, in some embodiments, N0 sending an information element containing hard (“H”), soft (“S”), and/or not applicable (“NA”) (“H/S/NA”) configuration information to a gNB.

In some embodiments of the first set of embodiments, H/S/NA configurations of individual IAB nodes are sent to a gNB. Then, the gNB may handle interference from H, S, and NA resources differently. For example, the gNB may realize that H resources associated with an JAB node may or may not cause a disruptive interference, and hence they may or may not require attention for scheduling, beam management, and so forth. Furthermore, NA resources for that JAB node may be free of interference from that JAB node, hence allowing the gNB more freedom for scheduling, beam management, and so forth.

In various embodiments of the first set of embodiments, H/S/NA configurations of multiple JAB nodes may be combined to save signaling overhead. For example: 1) N0 may indicate a resource as H if it is configured as H for at least one of the multiple JAB nodes; 2) NO may indicate a resource as NA if it is configured as NA for all of the multiple JAB nodes; and/or 3) N0 may indicate a resource as S if it is not indicated as H or NA. As may be appreciated, other schemes for combining information of H/S/NA configurations of multiple nodes are not precluded.

The first set of embodiments may maintain a tradeoff between useful information conveyed to a gNB and signaling overhead. To convey the most useful information, N0 may combine configuration information of multiple JAB nodes based on the JAB nodes' locations, their interference on the gNB, and so forth.

For example, N0 may combine H/S/NA information associated with JAB nodes that are within a distance from the gNB, as those JAB nodes may cause a more significant interference on the gNB compared to farther JAB nodes.

As another example, N0 may combine H/S/NA information associated with JAB nodes that cause an interference within a certain range. This interference may be obtained from the gNB over an Xn interface. Alternatively, the interference may be measured by the JAB nodes from the gNB, and then based on a reciprocity assumption, assume the interference that the JAB nodes cause on the gNB. In some embodiments, information of the interference range may be conveyed by N0 to the gNB.

As yet another example, N0 may combine H/S/NA information associated with multiple nodes based on mobility of the JAB nodes. For example, N0 may combine information associated with mobile JAB nodes and indicate that the interference associated with this information may be variable (e.g., due to mobility). The gNB may then take the information into account for scheduling, beam management, and so forth.

In certain embodiments of the first set of embodiments, if an IAB donor handles a majority of traffic and, hence, is allocated a majority of resources, a first information element (“JE”) containing legacy information may be sent to the gNB, while a second JE containing information of resources allocated to JAB nodes may be conveyed separately with an additional parameter. This parameter may indicate that the resources indicated in the second JE are used in a geographically distributed manner, hence causing interference that may be variable in magnitude and/or in a spatial domain. Then, the gNB may apply conventional methods for handling interference from resources indicated in the first IE, but it may apply alternative methods for handling interference from resources indicated in the second IE.

Although the first set of embodiments may have implementation simplicity, the first set of embodiments may not convey sufficient information to a victim node for an efficient interference management in some scenarios.

In some embodiments of a second set of embodiments, N0 may send information of dynamic availability indication (“AI”) of soft resources to a gNB.

In various embodiments of the second set of embodiments, IAB nodes may send AI information to NO. Then, N0 may collect and send this information to a gNB. According to such embodiments, the gNB obtains complete information of usage of soft resources, possibly in advance of scheduling and beam management (e.g., TCI state indication) for the UEs it is serving.

Although some embodiments of the second set of embodiments may provide complete information of resource usage by individual IAB nodes, they may have drawbacks. One drawback may be the signaling overhead over an Xn interface. In the presence of a large number of IAB systems and/or a large number IAB nodes in an IAB system, signaling overhead may be overwhelming. Another drawback may be that the second set of embodiments relies on sufficiently low latency on the Xn interface as well as F1 interfaces among the IAB nodes and the IAB donor N0 to deliver the information in a timely manner. The following alternative embodiments of the second set of embodiments aim to address the above drawbacks.

In certain embodiments of the second set of embodiments, an indication of soft resource usage by an IAB node, or multiple IAB nodes, may be sent by N0 to a gNB. For example, NO may send, to the gNB, information of a number of times M that a soft resource was indicated available to an IAB node in N periodicities. The ratio M/N may be used as an indication of traffic intensity for the soft resource in the near future. In such embodiments, the signaling overhead may be saved significantly as an average over multiple periodicities are sent rather than information associated with individual periodicities. Further, in such embodiments, the average is used as an indication of traffic intensity, hence requiring less strict latency over F1 and Xn interfaces.

In some embodiments of the second set of embodiments, an average may be taken over multiple IAB nodes. For example, N0 may send to a gNB, information of a number of IAB nodes M that a soft resource was indicated available to an IAB node in a set of N IAB nodes. A ratio M/N may be used as an indication of interference on a soft resource. In such embodiments, signaling overhead may be saved significantly as an average over multiple JAB nodes is sent rather than information associated with individual JAB nodes.

In various embodiments of the second set of embodiments, an average may be taken over multiple periodicities and multiple JAB nodes. For example, N0 may send to the gNB information of the number of times M that a soft resource was indicated available to NN JAB nodes in NP periodicities. The ratio M/(NN.NP) may be used as an indication of interference and traffic intensity on the soft resource in the near future. In such embodiments, the signaling overhead may be saved significantly as the average over multiple JAB nodes and multiple periodicities are sent rather than information associated with an individual JAB node in an individual periodicity. Further, the average is used as an indication of interference and traffic intensity, hence requiring less strict latency over F1 and Xn interfaces.

In the second set of embodiments, beam management (e.g., spatial) information, such as TCI state indication, may be collected by JAB nodes over an F1 interface and sent to the gNB for beam management purposes. Then, the gNB may combine the spatial information with the interference measurements on the associated resources and find correlations between, for example, TCI states and the level of interference they cause on the gNB. This information may then be used for further signaling between the gNB and the JAB system for interference coordination purposes.

In the second set of embodiments, information associated with JAB nodes that cause a less significant interference on a victim gNB may be omitted or sent less frequently compared to information associated with JAB nodes that cause a less significant interference on a victim gNB. Determining which JAB nodes may cause a more significant interference on a victim gNB may be obtained by location information, measurements by the gNB, measurements by JAB nodes plus a reciprocity assumption, or a combination thereof.

Embodiments described thus far may focus mainly on signaling between JAB systems (e.g., an IAB donor) and/or base stations (e.g., gNBs) to convey information of downlink (“DL”), uplink (“UL”), and/or flexible (“F”) (“DL/UL/F”) and H/S/NA configurations as well as dynamic indications that further indicate (or override) a direction of communication (e.g., DL, UL, etc.) or availability of a soft resource (e.g., is available, is not available, etc.). In such embodiments, performance in terms of timely communication of information may depend on a latency of possibly multiple wireless backhaul links (e.g., multi-hop JAB) which may not be acceptable. An approach to address such an issue may be to allow a gNB and/or an JAB node to determine information of a direction of communication and/or availability of a soft resource directly from an JAB node (e.g., over the air (“OTA”)). For example, the gNB or JAB node may determine such information by measuring a reference signal associated with that resource.

In some embodiments of a third set of embodiments, N0 sends JE containing information of a reference signal, such as a synchronization signal, a channel state information (“CSI”) reference signal (“RS”) (“CSI-RS”), a sounding reference signal (“SRS”), a reference signal for measuring cross-link interference, or the like, and an indication that associates the reference signal with a direction of transmission (e.g., DL, UL, etc.).

In various embodiments of the third set of embodiments, an IAB donor NO configures a resource for an JAB node N1 as F. Furthermore, N0 configures a reference signal, such as a CSI-RS, associated with the flexible resource. Then, if the resource is configured or indicated as DL by N0 or a parent of N1, N1 transmits the reference signal; otherwise, if the resource is not configured or indicated as DL by N0 or a parent of N1, N1 does not transmit the reference signal.

In certain embodiments of the third set of embodiments, an IAB donor NO configures a resource for an JAB node N1 as F. Furthermore, N0 configures a reference signal, such as an SRS, associated with the flexible resource. Then, if the resource is configured or indicated as UL by N0 or a parent of N1, N1 transmits the reference signal; otherwise, if the resource is not configured or indicated as UL by N0 or a parent of N1, N1 does not transmit the reference signal.

Different embodiments of the third set of embodiments may be combined for a resource. In one embodiment, an IAB donor N0 configures a resource for an JAB node N1 as F. Furthermore, N0 configures a first reference signal, such as a CSI-RS, and a second reference signal, such as an SRS, associated with the flexible resource. Then, if the resource is configured or indicated as DL by N0 or a parent of N1, N1 transmits the first reference signal; if the resource is configured or indicated as UL by N0 or a parent of N1, N1 transmits the second reference signal; otherwise, if the resource is not configured or indicated as DL or UL by N0 or a parent of N1, N1 does not either of the reference signals.

In various embodiments, N1 may transmit a reference signal associated with a resource while applying a transmit power, a beam, and/or a timing alignment mode associated with the resource. Then, a gNB or an JAB node and/or donor receiving the reference signal from N1 may measure a signal strength of the reference signal. The measurement result may then be used to manage interference, for example, by using the result for scheduling, power control, beam management, link adaptation, and so forth. In certain embodiments, a measured signal strength may be reported to another node, such as a parent node, such that it can perform scheduling, power control, beam management, link adaptation, and so forth. The node performing the measurement or receiving the measurement report may be a gNB or an JAB node and/or donor.

In some embodiments of the third set of embodiments, an IAB donor N0 configures a resource for an JAB node N1 as F. Furthermore, N0 configures a first reference signal, such as a CSI-RS, and a second reference signal, such as an SRS, associated with the flexible resource. Then, if N1 uses the resource for both DL and UL transmissions, for example in a frequency division multiplexing (“FDM”) and/or spatial division multiplexing (“SDM”) scheme, N1 may transmit both the first reference signal and the second reference signal. N1 may transmit the first reference signal associated with the resource while applying a transmit power, a beam, and/or a timing alignment mode associated with a DL signal to be transmitted on the resource. N1 may transmit the second reference signal associated with the resource while applying a transmit power, a beam, and/or a timing alignment mode associated with a UL signal to be transmitted on the resource. Then, a gNB or an JAB node and/or donor receiving either of the reference signals from N1 may measure a signal strength of the reference signals and use the measurement results for scheduling, power control, beam management, link adaptation, and so forth. In various embodiments, measured signal strengths may be reported to another node, such as a parent node, such that it can perform scheduling, power control, beam management, link adaptation, and so forth. The node performing the measurement or receiving the measurement report may be a gNB or an JAB node and/or donor. It should be noted that certain embodiments may be extended to a set of resources rather than a resource.

In some embodiments of the third set of embodiments, an IAB donor N0 configures a set of resources for an JAB node N1, where all or a subset of the resources in the set of resources may be configured as F. Furthermore, N0 may configure one or both of a first reference signal, such as a CSI-RS, and a second reference signal, such as an SRS, associated with the set of resources or a subset of the set of resource. Then, if N1 uses a resource from the set of the resources or a subset of the set of resources for DL, N1 may transmit the first reference signal. Similarly, if N1 uses a resource from the set of the resources or a subset of the set of resources for UL, N1 may transmit the second reference signal. If N1 uses a first resource from the set of the resources or a subset of the set of resources for DL, and if N1 uses a second resource from the set of the resources or a subset of the set of resources for UL, N1 may transmit both the first reference signal and the second reference signal. Such embodiments may include cases of FDM and/or SDM schemes.

In various embodiments of the third set of embodiments, N1 may transmit a first reference signal while applying a transmit power, a beam, and/or a timing alignment mode associated with a DL signal to be transmitted on the resources. If N1 is to transmit multiple DL signals on the resources, it may apply an average transmit power or a maximum transmit power associated with the DL signals. Similarly, N1 may transmit the second reference signal while applying a transmit power, a beam, and/or a timing alignment mode associated with a UL signal to be transmitted on the resources. If N1 is to transmit multiple UL signals on the resources, it may apply an average transmit power or a maximum transmit power associated with the UL signals. Such embodiments may include cases of FDM and/or SDM schemes.

In certain embodiments of the third set of embodiments, if N1 is to transmit multiple DL and UL signals on the resources, for example in an FDM and/or SDM scheme, it may apply an average transmit power or a maximum transmit power associated with the DL and UL signals subject to constraints such as a maximum power constraint, a beam constraint, a timing alignment mode constraint, and so forth. Such embodiments may include cases of FDM and/or SDM schemes.

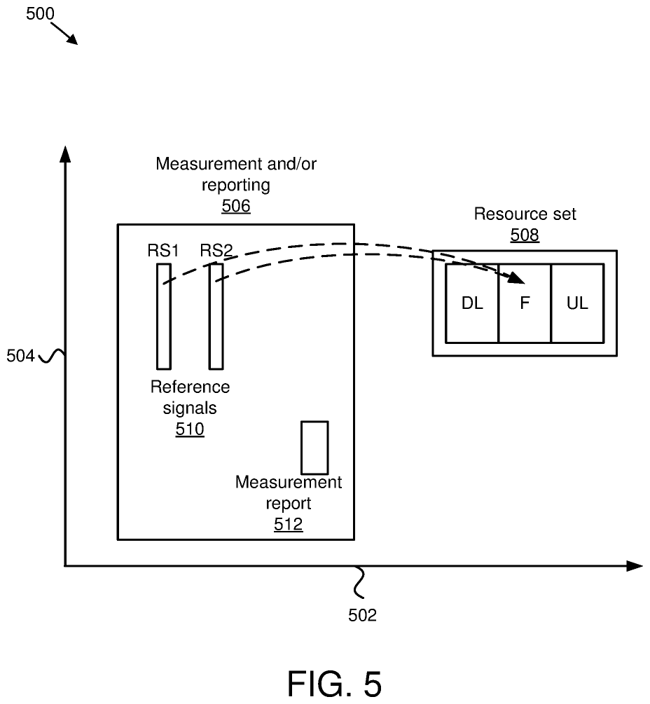

FIG. 5 is a schematic block diagram illustrating one embodiment of a system 500 showing a timeline and association between reference signals (e.g., as configured by an IAB-CU) and flexible resources over a time 502 and frequency range 504. Measurement and/or reporting 506 and a corresponding resource set 508 are illustrated. Moreover, the measurement and/or reporting 506 includes reference signals 510 (e.g., RS1 and RS2) and a measurement report 512. In FIG. 5, a first reference signal RS1 is associated with the F resources in the resource set for the DL direction, while a second reference signal RS2 is associated with the F resources in the resource configuration for the UL direction. Moreover, RS1 may be a downlink reference signal, such as a CSI-RS or a synchronization signal and/or physical broadcast channel (“SS/PBCH”), and RS2 may be an uplink reference signal, such as an SRS. The resource configuration may be in time and/or frequency domains and may span one or more symbols or slots in the time domain and one or more PRBs in the frequency domain. The resource configurations and the associated reference signals may be periodic, semi-persistent, or otherwise recurrent. Therefore, an occurrence of a reference signal (e.g., on recurring resources) may be associated with flexible resources in an occurrence of the resource set.

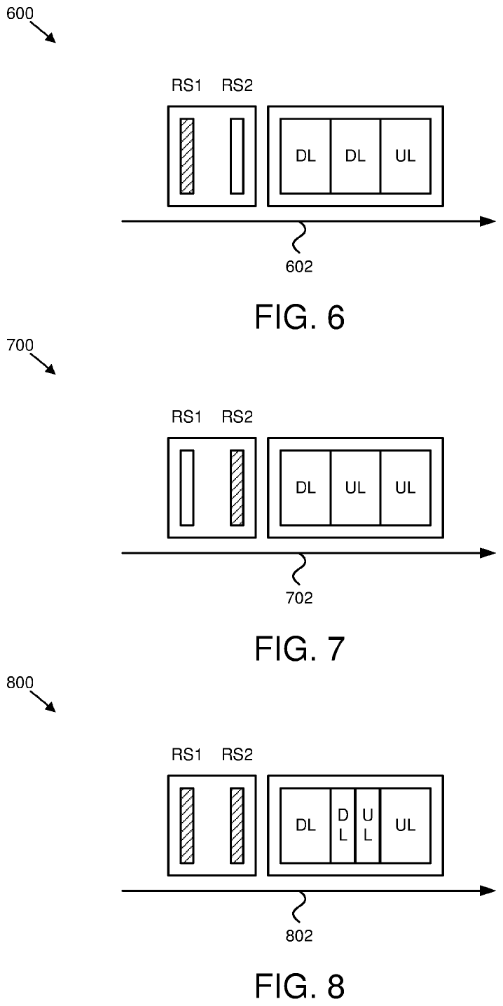

FIGS. 6 through 8 are schematic block diagrams illustrating embodiments of systems 600, 700, 800 showing a timeline and association between reference signals and flexible resources for time domain multiplexing over a time 602, 702, 802. In FIG. 6, if N1 uses the flexible resources for DL only, N1 transmits RS1 and does not transmit RS2 (e.g., the middle flexible resource set is used for DL). In FIG. 7, if N1 uses the flexible resources for UL only, N1 does not transmit RS1 and transmits RS2 (e.g., the middle flexible resource set is used for UL). In FIG. 8, if N1 uses some of the flexible resources for DL and some of the flexible resources for UL, N1 transmits both RS1 and RS2 (e.g., the middle flexible resource set is used for UL and DL).

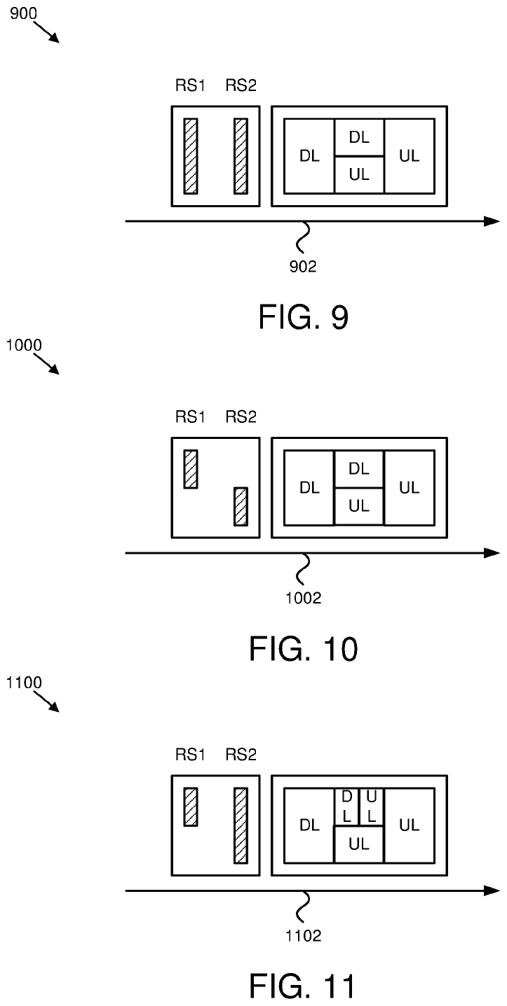

FIGS. 9 through 11 are schematic block diagrams illustrating embodiments of systems 900, 1000, 1100 showing a timeline and association between reference signals and flexible resources for frequency domain multiplexing and/or frequency domain multiplexing combined with time domain multiplexing over a time 902, 1002, 1102. In FIG. 9, if N1 uses the flexible resources for DL and UL in an FDM scheme, N1 may transmit RS1 and RS2 on all the frequency resources associated with RS1 and RS2, respectively (e.g., the middle flexible resource set is used for UL and DL). In FIG. 10, if N1 uses the flexible resources for DL and UL in an FDM scheme, N1 may transmit RS1 on a range of frequencies similar and/or equal to the range of frequencies where flexible resources are used for DL. Similarly, N1 may transmit RS2 on a range of frequencies similar and/or equal to the range of frequencies where flexible resources are used for UL (e.g., the middle flexible resource set is used for UL and DL). In FIG. 11, if different frequency ranges are used, N1 may transmit an associated reference signal (e.g., RS2) on a union of the frequency ranges (e.g., the middle flexible resource set is used for UL and DL).

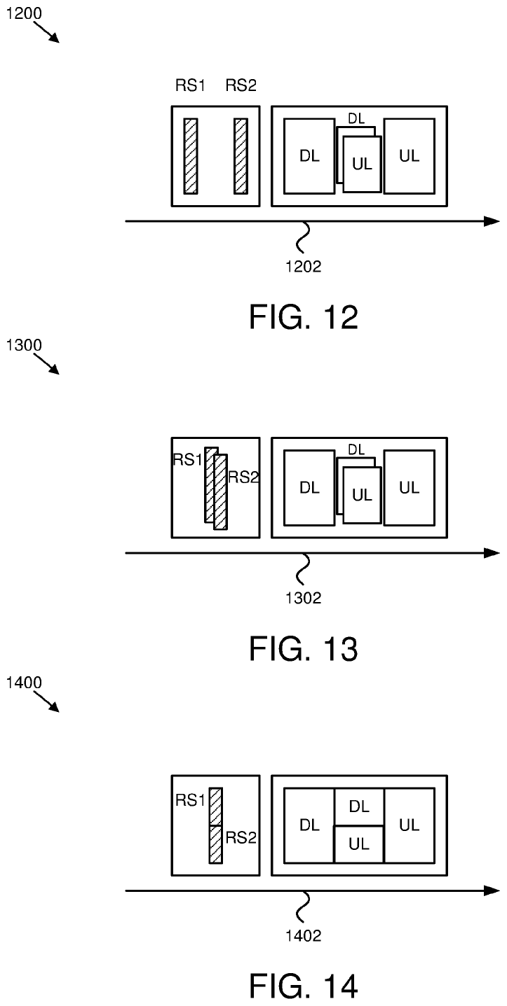

FIGS. 12 through 14 are schematic block diagrams illustrating embodiments of systems 1200, 1300, 1400 showing a timeline and association between reference signals and flexible resources for spatial domain multiplexing and/or frequency domain multiplexing over a time 1202, 1302, 1402. In FIG. 12, if N1 uses the flexible resources for DL and UL in an SDM scheme, N1 may transmit RS1 and RS2 on separate resources according to their respective configurations (e.g., the middle flexible resource set is used for UL and DL). In FIG. 13, if N1 uses the flexible resources for DL and UL in an SDM scheme, N1 may transmit RS1 and RS2 on same resource, where N1 may transmit RS1 on antenna panel and/or beam associated with the a DL transmission in the flexible resources, N1 may transmit RS2 on antenna panel and/or beam associated with the a UL transmission in the flexible resources (e.g., the middle flexible resource set is used for UL and DL). In FIG. 14, this method can be extended to the case of FDM (e.g., N1 transmits RS1 and RS2 on a same time resource such as a same OFDM symbol), while RS1 is transmitted on a frequency range similar and/or equal to the frequency range where flexible resources are used for DL, and RS2 is transmitted on a frequency range similar and/or equal to the frequency range where flexible resources are used for UL (e.g., the middle flexible resource set is used for UL and DL).

Any of the embodiments herein for TDM, FDM, and SDM may be specified by the standard and/or configured by the network such that the receiver can expect reference signal transmissions unambiguously.

In a fourth set of embodiments, there may be embodiments used to indicate a transmission on a soft resource instead of, or in addition to, indicating a direction of a transmission (e.g., DL, UL, etc.).

In some embodiments of the fourth set of embodiments, N0 sends an IE containing information of a reference signal, such as a synchronization signal, a CSI-RS, an SRS, a reference signal for measuring cross-link interference, or the like, and an indication that associates the reference signal with availability of soft resources.

In various embodiments of the fourth set of embodiments, an IAB donor NO configures a resource for an IAB node N1 as soft (“S”). Furthermore, N0 configures a reference signal associated with the soft resource. Then, if the resource is indicated as available by a parent of N1, N1 transmits the reference signal; otherwise, if the resource is not indicated as available by a parent of N1, N1 does not transmit the reference signal. In such embodiments, if the soft resource is configured as DL, the reference signal may be a downlink reference signal such as a CSI-RS, a primary synchronization signal (“PSS”), a secondary synchronization signal (“SSS”), an SS/PBCH block, or the like. If the soft resource is configured as UL, the reference signal may be an uplink reference signal such as an SRS.

In certain embodiments of the fourth set of embodiments, if a soft resource is configured as flexible (“F”), a first reference signal may be a downlink reference signal such as a CSI-RS, a PSS, an SSS, an SS/PBCH block, or the like, and a second reference signal may be an uplink reference signal such as an SRS. Then, if the resource is indicated as available for DL, N1 may transmit the first reference signal; if the resource is indicated as available for UL, N1 may transmit the second reference signal; if the resource is indicated as available for DL and UL, N1 may transmit both the first reference signal and the second reference signal; otherwise, if the resource is indicated as not available for DL and UL, N1 may transmit neither of the reference signals.

In some embodiments of the fourth set of embodiments, N1 may transmit a reference signal associated with a resource while applying a transmit power, a beam, and/or a timing alignment mode associated with the resource. Then, a gNB or an IAB node and/or donor receiving the reference signal from N1 may measure a signal strength of the reference signal. The measurement result may then be used to manage interference, for example, by using the result for scheduling, power control, beam management, link adaptation, and so forth. Alternatively, the measured signal strength may be reported to another node, such as a parent node, such that it can perform scheduling, power control, beam management, link adaptation, and so forth. The node performing the measurement or receiving the measurement report may be a gNB or an JAB node and/or donor.

Various embodiments of the fourth set of embodiments may be extended to a plurality of resources rather than a resource.

In certain embodiments of the fourth set of embodiments, an IAB donor NO configures a set of resources for an JAB node N1, where all or a subset of the resources in the set of resources may be configured as S. Furthermore, N0 may configure one or both of a first reference signal, such as a CSI-RS, and a second reference signal, such as an SRS, associated with the set of resources or a subset of the set of resource. Then, if a resource from the set of the resources or a subset of the set of resources is indicated available for DL, N1 may transmit the first reference signal. Similarly, if a resource from the set of the resources or a subset of the set of resources is indicated available for UL, N1 may transmit the second reference signal. If N1 uses a first resource from the set of the resources or a subset of the set of resources for DL, and if N1 uses a second resource from the set of the resources or a subset of the set of resources for UL, N1 may transmit both the first reference signal and the second reference signal. Such embodiments may include cases of FDM and/or SDM schemes.

In some embodiments of the fourth set of embodiments, N1 may transmit the first reference signal while applying a transmit power, a beam, and/or a timing alignment mode associated with a DL signal to be transmitted on the resources. If N1 is to transmit multiple DL signals on the resources, it may apply an average transmit power or a maximum transmit power associated with the DL signals. Similarly, N1 may transmit the second reference signal while applying a transmit power, a beam, and/or a timing alignment mode associated with a UL signal to be transmitted on the resources. If N1 is to transmit multiple UL signals on the resources, it may apply an average transmit power or a maximum transmit power associated with the UL signals. Such embodiments may include cases of FDM and/or SDM schemes.

In various embodiments of the fourth set of embodiments, if N1 is to transmit multiple DL and UL signals on the resources, for example in an FDM and/or SDM scheme, it may apply an average transmit power or a maximum transmit power associated with the DL and UL signals subject to constraints such as a maximum power constraint, a beam constraint, a timing alignment mode constraint, and so forth. Such embodiments may include cases of FDM and/or SDM schemes.

Embodiments found in the third set of embodiments and/or the fourth set of embodiments may address various issues. For example, signaling overhead may be saved significantly and latency of F1 and Xn interfaces may not be an issue as an availability indication may be inferred directly by a gNB by means of performing a measurement on reference signals directly from JAB nodes rather than receiving information over an Xn interface. The measurement may further (or originally) be an early interference measurement for handling an inter-cell interference (“ICI”), a cross-link interference (“CLI”), a remote interference, or the like.

Certain embodiments may be based on enhanced duplexing. In such embodiments, such as in 3GPP, there may be enhanced duplexing in JAB systems. An enhanced JAB system is expected to have enhanced capabilities for performing simultaneous operations (e.g., transmissions and/or receptions) in upstream (e.g., with a parent node) and downstream (e.g., with a child node or UE). The enhanced capabilities may include hardware capabilities, such as multiple antenna panels and multiple inverse discrete Fourier transform (“DFT”) (“IDFT”) and/or DFT windows for orthogonal frequency division multiplexing (“OFDM”) processing, as well as software and/or firmware capabilities to process enhanced resource configurations and signaling for FDM and/or SDM operations.

Examples of enhanced resource configurations, signaling, and other specification for simultaneous operations and enhanced duplexing in JAB systems may be as follows: 1) opportunistic and best-effort simultaneous transmissions (“TX”) and/or receptions (“RX”); 2) signaling capability of simultaneous TX and/or RX to adjacent JAB nodes; 3) extension of resource configurations and signaling to frequency and spatial domains for FDM and/or SDM; 4) new resource types for configuration and signaling; 5) priority rules for resolving cases of simultaneous operations that cannot be accommodated by an JAB node temporarily or permanently: a) temporarily (e.g., due to a constraint on beamforming or spatial filters, power, interference, and/or timing alignment); or b) permanently (e.g., due to a hardware limitation such as a number of antenna panels (e.g., SDM) or a number of IDFT and/or DFT windows (e.g., FDM)).

In certain embodiments of a fifth set of embodiments, an JAB node may use F resources configured by an JAB-CU for performing simultaneous operations. In such embodiments, communicating information of flexible resource configurations to an adjacent gNB may provide sufficient information for a gNB to handle additional interference caused by enhanced duplexing methods.

In some embodiments of the fifth set of embodiments, an JAB node may use resources that are indicated F by control signaling such as a slot format indication (“SFI”) message for performing simultaneous operations. In such embodiments, to communicate information of flexible resources to an adjacent gNB, an IAB-CU may collect information of flexible resource indications in the control signaling among JAB nodes. L1 and/or L2 control signaling may be performed on UE to network (“Uu”) links between JAB nodes, while the IAB-CU needs to collect this information from the JAB nodes over an F1 interface.

In various embodiments of the fifth set of embodiments, such as for communicating information including an AI to an adjacent gNB, transmitting information of flexible resources that are dynamically indicated by SFI messages may be impractical due to the large overhead as well as the latency introduced by the F1 interface in multi-hop JAB scenarios. It should be noted that an effect of variable interference due to geographically distributed JAB nodes in an JAB system may be exacerbated in multi-hop JAB systems where the F1 interface latency is also larger.

In certain embodiments of the fifth set of embodiments, an JAB node produces a digest of SFI messages over one or more periodicities and send it to the IAB-CU. Similar to embodiments proposed for AI, a digest may include information about a ratio of instances that a resource (e.g., such as slot or symbol or a number of physical resource blocks (“PRBs”)) is indicated DL, UL, F, available, or the like over one or more periodicities. Then, the information of the digest may be communicated to an adjacent gNB as a representative of an additional interference introduced by enhanced duplexing. In such embodiments, the JAB node may produce the digest over the SFI messages it transmits, receives, or a combination thereof.

In some embodiments of the fifth set of embodiments, a new configuration IE, such as a TDD-UL-DL-ConfigDedicated2-r17 or a TDD-UL-DL-ConfigDedicated2-IAB-MT-r17, may be used to configure resources for enhanced duplexing and to indicate signal priorities. The new configuration IE may be abbreviated as ConfigDedicated2 herein.

In various embodiments of the fifth set of embodiments, an JAB-CU may communicate information of ConfigDedicated2 to an adjacent gNB as an indication of additional interference that may be caused by enhanced duplexing. Then, as an example for gNB behavior, the gNB may consider a worst-case scenario for an interference from an adjacent JAB node that is connected to the JAB-CU, wherein the worst-case interference may be assumed as a summation of the interference caused by an upstream communication and a downstream communication of the JAB node.

In certain embodiments of the fifth set of embodiments, for simultaneous TX by the JAB node, an adjacent gNB may assume that an JAB node transmits in both DL and UL directions on resources that are configured by ConfigCommon, ConfigDedicated, ConfigDedicated2, or a combination thereof. The gNB may add interferences caused by a DL TX by the JAB node and a UL TX by the JAB node and compare the added value with a threshold for a level of interference.

In some embodiments of the fifth set of embodiments, for simultaneous RX by an IAB node, an adjacent gNB may assume that the IAB node receives in both DL and UL directions on resources that are configured by ConfigCommon, ConfigDedicated, ConfigDedicated2, or a combination thereof. The gNB may add interferences caused by a DL TX by a parent node of the IAB node and a UL TX by a child node of the IAB node and compare the added value with a threshold for a level of interference.

In various embodiments of the fifth set of embodiments, a value of interference caused by a TX by an IAB node, its parent node, or its child node may be determined by signaling and/or obtained by performing a measurement on a received signal strength (e.g., hence obtaining a received signal strength indicator (“RSSI”)) or a designated reference signal (as described in the third set of embodiments).

In certain embodiments of the fifth set of embodiments, a new resource type such as DL+UL may be used for configuration and/or control signaling that may enable simultaneous operation.

In some embodiments of the fifth set of embodiments, an IAB-CU may send, to an adjacent gNB, one or more configuration IEs including information about DL+UL resources, in addition to DL, UL, and/or flexible resources. Then, the gNB may assume a higher interference or a more variable interference on resources configured DL+UL compared to resources that are configured DL or UL.

In various embodiments of the fifth set of embodiments, if a resource is indicated by a new resource type such as DL+UL by a control signaling, the information of resource indications may be collected to produce a digest that may be sent to an IAB-CU that may send it to an adjacent gNB. The digest may be produced at an IAB node and sent to the IAB-CU over an F1 interface. In certain embodiments, an IAB-CU may collect raw information of all such control signaling from IAB nodes and produce the digest. Such embodiments may provide a higher flexibility for TDD interference coordination between the IAB system and the gNB at the cost of higher signaling overhead on the F1 interface.

In some embodiments of the fifth set of embodiments, resource configurations and/or control signaling may be overridden to perform simultaneous operations in a best-effort or opportunistic approach. In such embodiments, a simultaneous operation may be performed opportunistically by an IAB node or by coordination between adjacent IAB nodes, while this operation may be transparent to the rest of the IAB system including the IAB-CU. Moreover, in such embodiments, the IAB-CU may not have access to information regarding the additional interference that may be caused by a communication in a direction that is not reflected in dynamic TDD configurations.

In various embodiments of the fifth set of embodiments, an IAB node may send information about opportunistic simultaneous operations by overriding resource directions (e.g., transmitting an UL signal on a resource configured DL or vice versa) to the IAB-CU. Similar to other embodiments, the information sent to the IAB-CU may be raw or digest depending on a trade-off between flexibility and signaling overhead. Then, the IAB-CU may process the information to produce a digest or send the information as is to an adjacent gNB.

In certain embodiments of the fifth set of embodiments, a capability of simultaneous operation may be signaled dynamically by an IAB node based on hardware and/or software capabilities, as well as operation constraints such as spatial, power, interference, and/or timing alignment constraints. In such embodiments, information of simultaneous operation is in the control signaling that may be exchanged between adjacent IAB nodes while it is transparent to the rest of the IAB system including the IAB-CU.

In some embodiments of the fifth set of embodiments, an IAB-CU may collect control signaling information from IAB nodes and produce a digest for sending to an adjacent gNB. In such embodiments, an IAB node may produce a digest of the information for sending it to the IAB-CU. In a realization of such embodiments, an IAB node sends information of a ratio of instances, over one or more periodicities, that a resource or a plurality of resources in a periodicity are used for a simultaneous operation. For example, the IAB node may inform the IAB-CU that it has used a resource (e.g., a symbol or a slot) or a plurality of resource (e.g., all the flexible resources in a slot or multiple slots) M times for a simultaneous operation in a duration of N periodicities. Then, the ratio M/N may be used as a measure of interference caused by enhanced duplexing by the IAB node. In this example, the digest may be produced based on the control messages that the IAB node transmits, received, or a combination thereof.

In various embodiments of the fifth set of embodiments, an IAB node may further indicate in what DL and/or UL directions resources where used. In such embodiments, the IAB node may indicate for which case of simultaneous operation (e.g., Case A, B, C, or D) the resource was used. For example, a case of simultaneous TX (e.g., Case A) may indicate a severe interference from one IAB node, while a case of simultaneous RX (e.g., Case B) may indicate a distributed and/or variable interference by multiple nodes, such as a parent node and a child node of the IAB node. The IAB-CU may send this information to an adjacent gNB to allow the gNB to use this information, based on a specification or implementation, for handling the interference.

In certain embodiments of the fifth set of embodiments, priority rules for resolving conflicts between overlapping resources may be defined if an IAB node is not capable of performing a simultaneous operation on a resource temporarily or permanently.

In some embodiments of the fifth set of embodiments, information about priorities as configured by an IAB-CU may be sent to an adjacent gNB. Then, the gNB may consider the more persistent interference caused by a higher priority signal or the more variable interference caused by a lower priority signal on resources to handle the interferences.

In various embodiments of the fifth set of embodiments, information about priorities communicated by L1 and/or L2 signaling may be digested and/or communicated to a IAB-CU. The IAB-CU may then send this information to an adjacent gNB for interference coordination.

In certain embodiments of the fifth set of embodiments, there may be an extension to IAB-to-IAB embodiments. Specifically, embodiments herein have been described for IAB-to-gNB scenarios (e.g., where the aggressor is an IAB system and a victim is a gNB). Embodiments may be extended to IAB-to-IAB scenarios where the victim is another IAB system. Indeed, two or more IAB systems may communicate on an Xn interface based on the embodiments proposed herein for interference coordination purposes. Although each IAB system or IAB node may be an aggressor and a victim for an instance of interference, it may be assumed that one IAB system is the aggressor and one IAB system is the victim for each signaling instance. Therefore, for the embodiments in a sixth set of embodiments, consider the scenario where a first IAB system, dubbed IAB1 and configured by IAB-CU1 in IAB donor 1, is the aggressor and second IAB system, dubbed IAB2 and configured by IAB-CU2 in IAB donor 2, is the victim.

In some embodiments of the sixth set of embodiments, IAB donor 1 sends an IE to IAB donor 2. Then, IAB donor 2 receives the IE and distributes the information to all the IAB nodes configured and served by the IAB donor 2 over an F1 interface.

In various embodiments of the sixth set of embodiments, once IAB donor 2 receives the IE from IAB donor 1, it may process the information and send is selectively to the IAB nodes.

In certain embodiments of the sixth set of embodiments, IAB donor 1 sends information of resource configurations and reference signals, for example according to the third set of embodiments. Then, IAB donor 2 may send the information selectively to IAB nodes such that only information of IAB nodes from IAB1 that are in a vicinity of an IAB node from IAB2 are sent to the IAB node. For example, if IAB1 includes IAB nodes N1 and N2 and IAB2 includes an IAB node N3, and if the interference from N1 on N3 is strong, but the interference from N2 on N3 is not strong, IAB donor 2 may send configuration and RS information associated with N1 to JAB node N3, but not configuration and RS information associated with N2 to JAB node N3.

In some embodiments of the sixth set of embodiments, IAB donor 2 may decide on what information to send to which JAB node based on a geographical distance between an aggressor JAB node from JAB1 and a victim JAB node in IAB2. For such embodiments, location information of N3 may be collected by IAB donor 2, while location information of N1 and N2 may be collected by IAB donor 1 and sent to IAB donor 2. A value of maximum distance between an aggressor and a victim may also be configured for IAB donor 2. Then, IAB donor 2 may send configuration and RS information associated with N1 to N3 if the distance between N1 and N3 is not larger than the value of maximum distance.

In various embodiments of the sixth set of embodiments, IAB donor 2 may initially send information associated to both N1 and N2 to N3. Then, N3 may inform IAB-CU2 that the interference from N1 is larger than a threshold while the interference from N2 is smaller than a threshold. Then, realizing that N3 does not seek to get updated information about N3, IAB donor 2 may only send information associated with N1 to N2 in the next iterations.

In certain embodiments of the sixth set of embodiments, the information that IAB donor 1 sends to IAB donor 2 may not include information of JAB nodes, but instead, information of resource configurations and associated RSs. Then, IAB donor 2 may distribute information of configurations and RSs among JAB nodes of IAB2 based on a level of interference one the resources associated with the configuration as measured on the associated RSs.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mmWave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal block (“SSB”), CSI-RS, and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

In various embodiments described herein, although entities are referred to as IAB nodes, the same embodiments can be applied to IAB donors (e.g., which are the IAB entities connecting the core network to the IAB network) with minimum or zero modifications. Moreover, different steps described for different embodiments may be permuted. Further, each configuration may be provided by one or more configurations in practice. An earlier configuration may provide a subset of parameters while a later configuration may provide another subset of parameters. In certain embodiments, a later configuration may override values provided by an earlier configuration or a pre-configuration.

In some embodiments, a configuration may be provided by radio resource control (“RRC”) signaling, medium-access control (“MAC”) signaling, physical layer signaling such as a downlink control information (“DCI”) message, a combination thereof, or other methods. A configuration may include a pre-configuration or a semi-static configuration provided by a standard, by a vendor, and/or by a network and/or operator. Each parameter value received through configuration or indication may override previous values for a similar parameter.

In various embodiments, despite frequent references to IAB, embodiments herein may be applicable to wireless relay nodes and other types of wireless communication entities. Further, layer 1 (“L1”) and/or layer 2 (“L2”) control signaling may refer to control signaling in layer 1 (e.g., physical layer) or layer 2 (e.g., data link layer). Particularly, an L1 and/or L2 control signaling may refer to an L1 control signaling such as a DCI message or an uplink control information (“UCI”) message, an L2 control signaling such as a MAC message, or a combination thereof. A format and an interpretation of an L1 and/or L2 control signaling may be determined by a standard, a configuration, other control signaling, or a combination thereof.

It should be noted that any parameter discussed in this disclosure may appear, in practice, as a linear function of that parameter in signaling or specifications.

In certain embodiments, in any timing assignment for a slot that contains a signal, a timing assignment by a sign such as ‘=’ or ‘:=’ or a like may mean that the start time of the slot containing the signal is equal to a determined value such as a right hand side of the equation. In some embodiments, a start time of the slot containing the signal may be different from the determined value by an integer multiple of Tₛₗₒₜ, where Tₛₗₒₜ denotes a slot duration for a given numerology or subcarrier spacing (“SCS”). This may be applicable to all timing assignments found herein. In various embodiments, the values may be different by an integer multiple of T_{symbol} rather than an integer multiple of Tₛₗₒₜ, where T_{symbol} denotes a symbol duration for a given numerology or SCS.

In various embodiments, vendor manufacturing IAB systems and/or devices and an operator deploying the IAB systems and/or devices may be allowed to negotiate capabilities of the systems and/or devices. This may mean that some of the information assumed to need signaling between entities may readily be available to the devices, for example, by storing the information on a memory unit such as a read-only memory (“ROM”), exchanging the information by proprietary signaling methods, providing the information by a (pre)configuration, or otherwise taking the information into account when creating hardware and/or software of the IAB systems and/or devices or other entities in the network. In certain embodiments, embodiments described herein that include exchanging information may be extended to similar embodiments wherein the information is obtained by other embodiments.

Further, embodiments used for an IAB mobile terminal (“MT”) (“IAB-MT”) may be adopted by a UE as well. If an embodiment uses a capability that is not supported by a legacy UE, a UE enhanced to possess the capability may be used. In this case, the UE may be referred to as an enhanced UE or an IAB-enhanced UE and may convey its information of its enhanced capability to the network for proper configuration and operation.

As used herein, a node or a wireless node may refer to an IAB node, an IAB-DU, an IAB-MT, a UE, a base station (“BS”), a gNodeB (“gNB”), a transmit-receive point (“TRP”), an IAB donor, and so forth. The embodiments herein with an emphasis on a type of nodes are not meant to limit scope.

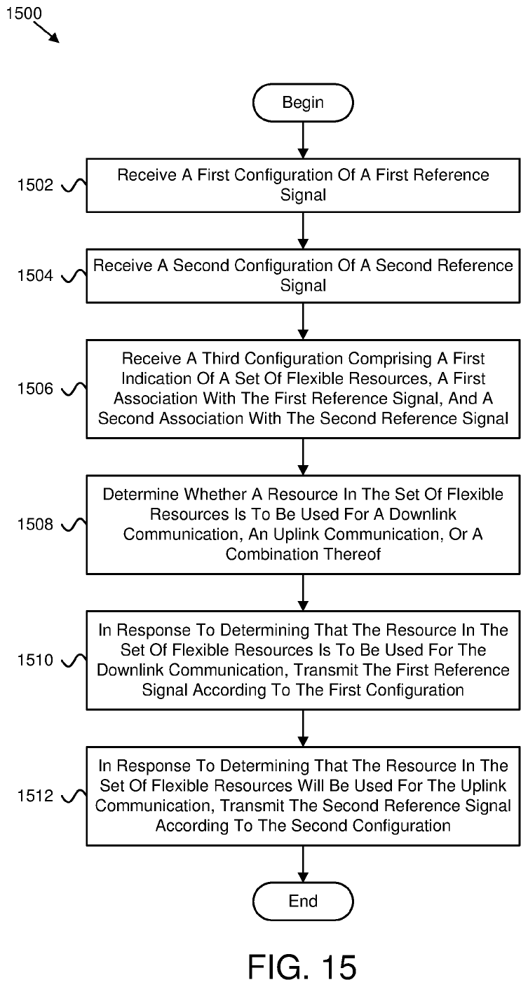

FIG. 15 is a flow chart diagram illustrating one embodiment of a method 1500 for flexible resource configuration for wireless communication. In some embodiments, the method 1500 is performed by an apparatus, such as the network unit 104. In certain embodiments, the method 1500 may be performed by a processor executing program code, for example, a microcontroller, a microprocessor, a CPU, a GPU, an auxiliary processing unit, a FPGA, or the like.

In various embodiments, the method 1500 includes receiving 1502, at a wireless node, a first configuration of a first reference signal. In some embodiments, the method 1500 includes receiving 1504 a second configuration of a second reference signal. In certain embodiments, the method 1500 includes receiving 1506 a third configuration including a first indication of a set of flexible resources, a first association with the first reference signal, and a second association with the second reference signal. In various embodiments, the method 1500 includes determining 1508 whether a resource in the set of flexible resources is to be used for a downlink communication, an uplink communication, or a combination thereof. In some embodiments, the method 1500 includes, in response to determining that the resource in the set of flexible resources is to be used for the downlink communication, transmitting 1510 the first reference signal according to the first configuration. In certain embodiments, the method 1500 includes, in response to determining that the resource in the set of flexible resources will be used for the uplink communication, transmitting 1512 the second reference signal according to the second configuration.

In certain embodiments, the wireless node comprises a base station, an integrated access and backhaul donor, an integrated access and backhaul node, a user equipment, or some combination thereof. In some embodiments, the method 1500 further comprises selecting a first frequency range for the first reference signal based on a second frequency range of the downlink communication. In various embodiments, the method 1500 further comprises selecting a first frequency range for the second reference signal based on a second frequency range of the uplink communication.

In one embodiment, the method 1500 comprises: selecting a first frequency range for the first reference signal based on a second frequency range of the downlink communication; and selecting a third frequency range for the second reference signal based on a fourth frequency range of the uplink communication, wherein a first overlap of the first frequency range and the third frequency range indicates a second overlap of the second frequency range and the fourth frequency range. In certain embodiments, the first reference signal and the second reference signal are transmitted using the same frequency resources and different time resources.

In some embodiments, transmission of the first reference signal and the second reference signal using the same frequency resources and different time resources indicates that the downlink communication and the uplink communication are to be communicated using the same frequency resources and different time resources. In various embodiments, transmission of the first reference signal and the second reference signal using the same frequency resources and different time resources indicates that the downlink communication and the uplink communication are to be communicated using different frequency resources and the same time resources. In one embodiment, transmission of the first reference signal and the second reference signal using the same frequency resources and different time resources indicates that the downlink communication and the uplink communication are to be communicated using the same frequency resources, the same time resources, and different spatial resources.

In certain embodiments, the first reference signal and the second reference signal are transmitted using different frequency resources and different time resources. In some embodiments, transmission of the first reference signal and the second reference signal using different frequency resources and different time resources indicates that the downlink communication and the uplink communication are to be communicated using the same time resources and different frequency resources. In various embodiments, the first reference signal and the second reference signal are transmitted using different frequency resources and the same time resources.

In one embodiment, transmission of the first reference signal and the second reference signal using different frequency resources and the same time resources indicates that the downlink communication and the uplink communication are to be communicated using the same time resources and different frequency resources. In certain embodiments, the first reference signal and the second reference signal are transmitted using overlapping frequency resources and different time resources. In some embodiments, transmission of the first reference signal and the second reference signal using overlapping frequency resources and different time resources indicates that the downlink communication and the uplink communication are to be communicated using the same time resources and different frequency resources.

In various embodiments, the method 1500 further comprises applying a first spatial filter to the first reference signal in association with a second spatial filter applied to the downlink communication. In one embodiment, the first spatial filter and the second spatial filter are identical. In certain embodiments, the method 1500 further comprises applying a first spatial filter to the second reference signal in association with a second spatial filter applied to the uplink communication.

In some embodiments, the first spatial filter and the second spatial filter are identical. In various embodiments, the first reference signal and the second reference signal are transmitted using the same frequency resources, the same time resources, and different spatial resources. In one embodiment, transmission of the first reference signal and the second reference signal using the same frequency resources, the same time resources, and different spatial resources indicates that the downlink communication and the uplink communication are to be communicated using the same time resources, the same frequency resources, and different spatial resources.

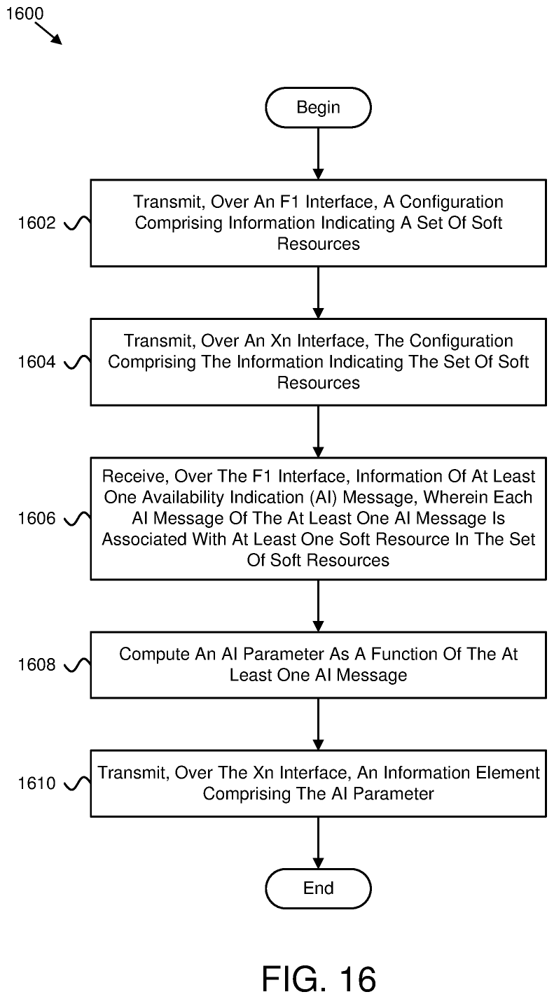

FIG. 16 is a flow chart diagram illustrating another embodiment of a method 1600 for flexible resource configuration for wireless communication. In some embodiments, the method 1600 is performed by an apparatus, such as the network unit 104. In certain embodiments, the method 1600 may be performed by a processor executing program code, for example, a microcontroller, a microprocessor, a CPU, a GPU, an auxiliary processing unit, a FPGA, or the like.

In various embodiments, the method 1600 includes transmitting 1602, from a wireless entity over an F1 interface, a configuration comprising information indicating a set of soft resources. In some embodiments, the method 1600 includes transmitting 1604, over an Xn interface, the configuration including the information indicating the set of soft resources. In certain embodiments, the method 1600 includes receiving 1606, over the F1 interface, information of at least one availability indication (AI) message. Each AI message of the at least one AI message is associated with at least one soft resource in the set of soft resources. In various embodiments, the method 1600 includes computing 1608 an AI parameter as a function of the at least one AI message. In some embodiments, the method 1600 includes transmitting 1610, over the Xn interface, an information element including the AI parameter.

In certain embodiments, the function is a field-wise average, a field-wise logical OR function, a field-wise logical AND function or a combination thereof of the at least one AI message. In some embodiments, the at least one AI message is associated with at least one integrated access and backhaul node. In various embodiments, the wireless node comprises a base station, an integrated access and backhaul donor, an integrated access and backhaul node, a user equipment, or some combination thereof.

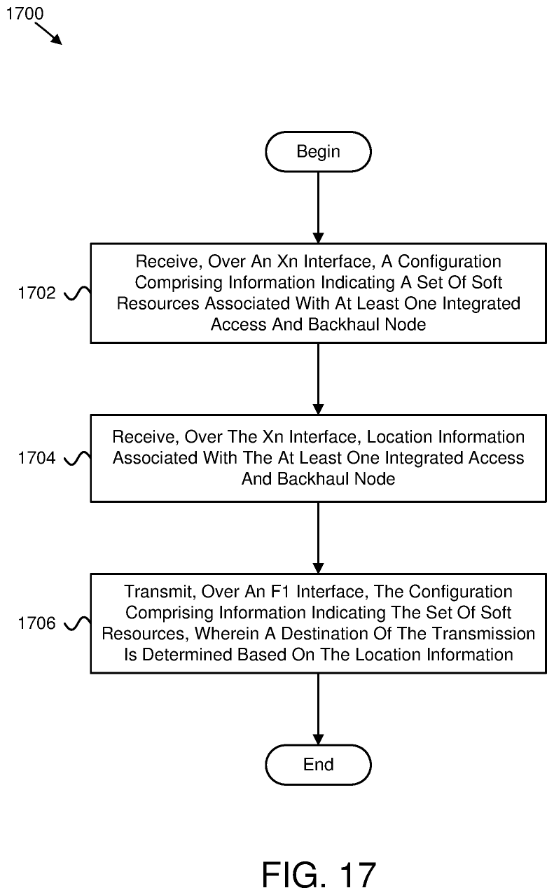

FIG. 17 is a flow chart diagram illustrating a further embodiment of a method 1700 for flexible resource configuration for wireless communication. In some embodiments, the method 1700 is performed by an apparatus, such as the network unit 104. In certain embodiments, the method 1700 may be performed by a processor executing program code, for example, a microcontroller, a microprocessor, a CPU, a GPU, an auxiliary processing unit, a FPGA, or the like.

In various embodiments, the method 1700 includes receiving 1702, by a wireless entity over an Xn interface, a configuration including information indicating a set of soft resources associated with at least one integrated access and backhaul node. In some embodiments, the method 1700 includes receiving 1704, over the Xn interface, location information associated with the at least one integrated access and backhaul node. In certain embodiments, the method 1700 includes transmitting 1706, over an F1 interface, the configuration including information indicating the set of soft resources. A destination of the transmission is determined based on the location information.

In certain embodiments, determining the destination based on the location information comprises determining whether the destination is within an interference range of the at least one integrated access and backhaul node.

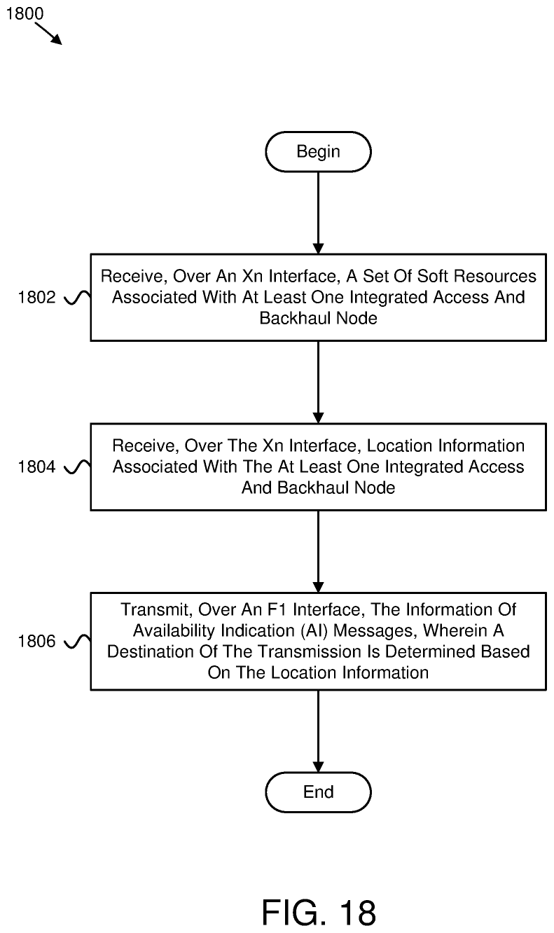

FIG. 18 is a flow chart diagram illustrating yet another embodiment of a method 1800 for flexible resource configuration for wireless communication. In some embodiments, the method 1800 is performed by an apparatus, such as the network unit 104. In certain embodiments, the method 1800 may be performed by a processor executing program code, for example, a microcontroller, a microprocessor, a CPU, a GPU, an auxiliary processing unit, a FPGA, or the like.

In various embodiments, the method 1800 includes receiving 1802, at a wireless entity over an Xn interface, a set of soft resources associated with at least one integrated access and backhaul node. In some embodiments, the method 1800 includes receiving 1804, over the Xn interface, location information associated with the at least one integrated access and backhaul node. In certain embodiments, the method 1800 includes transmitting 1806, over an F1 interface, the information of availability indication (AI) messages. A destination of the transmission is determined based on the location information.

In certain embodiments, determining the destination based on the location information comprises determining whether the destination is within an interference range of the at least one integrated access and backhaul node.

In one embodiment, a method of a wireless node comprises: receiving a first configuration of a first reference signal; receiving a second configuration of a second reference signal; receiving a third configuration comprising a first indication of a set of flexible resources, a first association with the first reference signal, and a second association with the second reference signal; determining whether a resource in the set of flexible resources is to be used for a downlink communication, an uplink communication, or a combination thereof; in response to determining that the resource in the set of flexible resources is to be used for the downlink communication, transmitting the first reference signal according to the first configuration; and in response to determining that the resource in the set of flexible resources will be used for the uplink communication, transmitting the second reference signal according to the second configuration.

In certain embodiments, the wireless node comprises a base station, an integrated access and backhaul donor, an integrated access and backhaul node, a user equipment, or some combination thereof.

In some embodiments, the method further comprises selecting a first frequency range for the first reference signal based on a second frequency range of the downlink communication.

In various embodiments, the method further comprises selecting a first frequency range for the second reference signal based on a second frequency range of the uplink communication.

In one embodiment, the method comprises: selecting a first frequency range for the first reference signal based on a second frequency range of the downlink communication; and selecting a third frequency range for the second reference signal based on a fourth frequency range of the uplink communication, wherein a first overlap of the first frequency range and the third frequency range indicates a second overlap of the second frequency range and the fourth frequency range.

In certain embodiments, the first reference signal and the second reference signal are transmitted using the same frequency resources and different time resources.

In some embodiments, transmission of the first reference signal and the second reference signal using the same frequency resources and different time resources indicates that the downlink communication and the uplink communication are to be communicated using the same frequency resources and different time resources.

In various embodiments, transmission of the first reference signal and the second reference signal using the same frequency resources and different time resources indicates that the downlink communication and the uplink communication are to be communicated using different frequency resources and the same time resources.

In one embodiment, transmission of the first reference signal and the second reference signal using the same frequency resources and different time resources indicates that the downlink communication and the uplink communication are to be communicated using the same frequency resources, the same time resources, and different spatial resources.

In certain embodiments, the first reference signal and the second reference signal to are transmitted using different frequency resources and different time resources.

In some embodiments, transmission of the first reference signal and the second reference signal using different frequency resources and different time resources indicates that the downlink communication and the uplink communication are to be communicated using the same time resources and different frequency resources.

In various embodiments, the first reference signal and the second reference signal are transmitted using different frequency resources and the same time resources.

In one embodiment, transmission of the first reference signal and the second reference signal using different frequency resources and the same time resources indicates that the downlink communication and the uplink communication are to be communicated using the same time resources and different frequency resources.

In certain embodiments, the first reference signal and the second reference signal are transmitted using overlapping frequency resources and different time resources.

In some embodiments, transmission of the first reference signal and the second reference signal using overlapping frequency resources and different time resources indicates that the downlink communication and the uplink communication are to be communicated using the same time resources and different frequency resources.

In various embodiments, the method further comprises applying a first spatial filter to the first reference signal in association with a second spatial filter applied to the downlink communication.

In one embodiment, the first spatial filter and the second spatial filter are identical.

In certain embodiments, the method further comprises applying a first spatial filter to the second reference signal in association with a second spatial filter applied to the uplink communication.

In some embodiments, the first spatial filter and the second spatial filter are identical.

In various embodiments, the first reference signal and the second reference signal are transmitted using the same frequency resources, the same time resources, and different spatial resources.

In one embodiment, transmission of the first reference signal and the second reference signal using the same frequency resources, the same time resources, and different spatial resources indicates that the downlink communication and the uplink communication are to be communicated using the same time resources, the same frequency resources, and different spatial resources.

In one embodiment, an apparatus comprises a wireless node. The apparatus further comprises: a receiver that: receives a first configuration of a first reference signal; receives a second configuration of a second reference signal; and receives a third configuration comprising a first indication of a set of flexible resources, a first association with the first reference signal, and a second association with the second reference signal; a processor that determines whether a resource in the set of flexible resources is to be used for a downlink communication, an uplink communication, or a combination thereof; and a transmitter that: in response to determining that the resource in the set of flexible resources is to be used for the downlink communication, transmits the first reference signal according to the first configuration; and, in response to determining that the resource in the set of flexible resources will be used for the uplink communication, transmits the second reference signal according to the second configuration.

In certain embodiments, the wireless node comprises a base station, an integrated access and backhaul donor, an integrated access and backhaul node, a user equipment, or some combination thereof.

In some embodiments, the processor selects a first frequency range for the first reference signal based on a second frequency range of the downlink communication.

In various embodiments, the processor selects a first frequency range for the second reference signal based on a second frequency range of the uplink communication.

In one embodiment: the processor selects a first frequency range for the first reference signal based on a second frequency range of the downlink communication; and the processor selects a third frequency range for the second reference signal based on a fourth frequency range of the uplink communication, wherein a first overlap of the first frequency range and the third frequency range indicates a second overlap of the second frequency range and the fourth frequency range.

In certain embodiments, the first reference signal and the second reference signal are transmitted using the same frequency resources and different time resources.

In some embodiments, transmission of the first reference signal and the second reference signal using the same frequency resources and different time resources indicates that the downlink communication and the uplink communication are to be communicated using the same frequency resources and different time resources.

In various embodiments, transmission of the first reference signal and the second reference signal using the same frequency resources and different time resources indicates that the downlink communication and the uplink communication are to be communicated using different frequency resources and the same time resources.

In one embodiment, transmission of the first reference signal and the second reference signal using the same frequency resources and different time resources indicates that the downlink communication and the uplink communication are to be communicated using the same frequency resources, the same time resources, and different spatial resources.

In certain embodiments, the first reference signal and the second reference signal are transmitted using different frequency resources and different time resources.

In some embodiments, transmission of the first reference signal and the second reference signal using different frequency resources and different time resources indicates that the downlink communication and the uplink communication are to be communicated using the same time resources and different frequency resources.

In various embodiments, the first reference signal and the second reference signal are transmitted using different frequency resources and the same time resources.

In one embodiment, transmission of the first reference signal and the second reference signal using different frequency resources and the same time resources indicates that the downlink communication and the uplink communication are to be communicated using the same time resources and different frequency resources.

In certain embodiments, the first reference signal and the second reference signal are transmitted using overlapping frequency resources and different time resources.

In some embodiments, transmission of the first reference signal and the second reference signal using overlapping frequency resources and different time resources indicates that the downlink communication and the uplink communication are to be communicated using the same time resources and different frequency resources.

In various embodiments, the processor applies a first spatial filter to the first reference signal in association with a second spatial filter applied to the downlink communication.

In one embodiment, the first spatial filter and the second spatial filter are identical.

In certain embodiments, the processor applies a first spatial filter to the second reference signal in association with a second spatial filter applied to the uplink communication.

In some embodiments, the first spatial filter and the second spatial filter are identical.

In various embodiments, the first reference signal and the second reference signal are transmitted using the same frequency resources, the same time resources, and different spatial resources.

In one embodiment, transmission of the first reference signal and the second reference signal using the same frequency resources, the same time resources, and different spatial resources indicates that the downlink communication and the uplink communication are to be communicated using the same time resources, the same frequency resources, and different spatial resources.

In one embodiment, a method of a wireless entity comprises: transmitting, over an F1 interface, a configuration comprising information indicating a set of soft resources; transmitting, over an Xn interface, the configuration comprising the information indicating the set of soft resources; receiving, over the F1 interface, information of at least one availability indication (AI) message, wherein each AI message of the at least one AI message is associated with at least one soft resource in the set of soft resources; computing an AI parameter as a function of the at least one AI message; and transmitting, over the Xn interface, an information element comprising the AI parameter.

In certain embodiments, the function is a field-wise average, a field-wise logical OR function, a field-wise logical AND function or a combination thereof of the at least one AI message.

In some embodiments, the at least one AI message is associated with at least one integrated access and backhaul node.

In various embodiments, the wireless node comprises a base station, an integrated access and backhaul donor, an integrated access and backhaul node, a user equipment, or some combination thereof.

In one embodiment, an apparatus comprises a wireless entity. The apparatus further comprises: a transmitter that: transmits, over an F1 interface, a configuration comprising information indicating a set of soft resources; and transmits, over an Xn interface, the configuration comprising the information indicating the set of soft resources; a receiver that receives, over the F1 interface, information of at least one availability indication (AI) message, wherein each AI message of the at least one AI message is associated with at least one soft resource in the set of soft resources; and a processor that computes an AI parameter as a function of the at least one AI message, wherein the transmitter transmits, over the Xn interface, an information element comprising the AI parameter.

In certain embodiments, the function is a field-wise average, a field-wise logical OR function, a field-wise logical AND function or a combination thereof of the at least one AI message.

In some embodiments, the at least one AI message is associated with at least one integrated access and backhaul node.

In various embodiments, the wireless node comprises a base station, an integrated access and backhaul donor, an integrated access and backhaul node, a user equipment, or some combination thereof.

In one embodiment, a method of a wireless entity comprises: receiving, over an Xn interface, a configuration comprising information indicating a set of soft resources associated with at least one integrated access and backhaul node; receiving, over the Xn interface, location information associated with the at least one integrated access and backhaul node; and transmitting, over an F1 interface, the configuration comprising information indicating the set of soft resources, wherein a destination of the transmission is determined based on the location information.

In certain embodiments, determining the destination based on the location information comprises determining whether the destination is within an interference range of the at least one integrated access and backhaul node.

In one embodiment, an apparatus comprises a wireless entity. The apparatus further comprises: a receiver that: receives, over an Xn interface, a configuration comprising information indicating a set of soft resources associated with at least one integrated access and backhaul node; and receives, over the Xn interface, location information associated with the at least one integrated access and backhaul node; and a transmitter that transmits, over an F1 interface, the configuration comprising information indicating the set of soft resources, wherein a destination of the transmission is determined based on the location information.

In certain embodiments, determining the destination based on the location information comprises determining whether the destination is within an interference range of the at least one integrated access and backhaul node.

In one embodiment, a method of a wireless entity comprises: receiving, over an Xn interface, a set of soft resources associated with at least one integrated access and backhaul node; receiving, over the Xn interface, location information associated with the at least one integrated access and backhaul node; and transmitting, over an F1 interface, the information of availability indication (AI) messages, wherein a destination of the transmission is determined based on the location information.

In certain embodiments, determining the destination based on the location information comprises determining whether the destination is within an interference range of the at least one integrated access and backhaul node.

In one embodiment, an apparatus comprises a wireless entity. The apparatus further comprises: a receiver that: receives, over an Xn interface, a set of soft resources associated with at least one integrated access and backhaul node; and receives, over the Xn interface, location information associated with the at least one integrated access and backhaul node; and a transmitter that transmits, over an F1 interface, the information of availability indication (AI) messages, wherein a destination of the transmission is determined based on the location information.

In certain embodiments, determining the destination based on the location information comprises determining whether the destination is within an interference range of the at least one integrated access and backhaul node.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A wireless node, comprising:
at least one memory; and
at least one processor coupled with the at least one memory and configured to cause the wireless node to:
receive a first configuration of a first reference signal;
receive a second configuration of a second reference signal;
receive a third configuration comprising a first indication of a set of flexible resources, a first association with the first reference signal, and a second association with the second reference signal;
determine whether a resource in the set of flexible resources is to be used for a downlink communication, an uplink communication, or a combination thereof;
in response to determining that the resource in the set of flexible resources is to be used for the downlink communication, transmit the first reference signal according to the first configuration; and
in response to determining that the resource in the set of flexible resources will be used for the uplink communication, transmit the second reference signal according to the second configuration.

2. The wireless node of claim 1, further comprising a base station, an integrated access and backhaul (IAB) donor, an IAB node, a user equipment (UE), or a combination thereof.

3. The wireless node of claim 1, wherein the at least one processor is configured to cause the wireless node to select a first frequency range for the first reference signal based on a second frequency range of the downlink communication.

4. The wireless node of claim 1, wherein:
the at least one processor is configured to cause the wireless node to select a first frequency range for the first reference signal based on a second frequency range of the downlink communication; and
the at least one processor is configured to cause the wireless node to select a third frequency range for the second reference signal based on a fourth frequency range of the uplink communication, wherein a first overlap of the first frequency range and the third frequency range indicates a second overlap of the second frequency range and the fourth frequency range.

5. The wireless node of claim 1, wherein the first reference signal and the second reference signal are transmitted using the same frequency resources and different time resources.

6. The wireless node of claim 1, wherein the first reference signal and the second reference signal are transmitted using different frequency resources and different time resources.

7. The wireless node of claim 1, wherein the first reference signal and the second reference signal are transmitted using different frequency resources and the same time resources.

8. The wireless node of claim 1, wherein the first reference signal and the second reference signal are transmitted using overlapping frequency resources and different time resources.

9. The wireless node of claim 1, wherein the at least one processor is configured to cause the wireless node to apply a first spatial filter to the first reference signal in association with a second spatial filter applied to the downlink communication.

10. The wireless node of claim 1, wherein the at least one processor is configured to cause the wireless node to apply a first spatial filter to the second reference signal in association with a second spatial filter applied to the uplink communication.

11. A wireless entity, comprising:
at least one memory; and
at least one processor coupled with the at least one memory and configured to cause the wireless node to:
transmit, over an F1 interface, a configuration comprising information indicating a set of soft resources;
transmit, over an Xn interface, the configuration comprising the information indicating the set of soft resources;
receive, over the F1 interface, information of at least one availability indication (AI) message, wherein each AI message of the at least one AI message is associated with at least one soft resource in the set of soft resources; and
compute an AI parameter as a function of the at least one AI message, wherein the transmitter transmits, over the Xn interface, an information element comprising the AI parameter.

12. The wireless entity of claim 11, wherein the function is a field-wise average, a field-wise logical OR function, a field-wise logical AND function or a combination thereof of the at least one AI message.

13. The wireless entity of claim 11, wherein the at least one AI message is associated with at least one integrated access and backhaul node.

14. (canceled)

15. (canceled)

16. An integrated access and backhaul (IAB) donor, comprising:
at least one memory; and
at least one processor coupled with the at least one memory and configured to cause the IAB donor to:
send, to an IAB distributed unit (IAB-DU), at least one of:
a first configuration comprising first information indicating whether a plurality of symbols is hard, soft, unavailable, or a combination thereof, wherein a hard symbol is always available, a soft symbol is conditionally available, and an unavailable symbol is never available for a first communication by the IAB-DU; and
a second configuration comprising second information indicating whether a plurality of physical resource blocks (PRBs) is hard, soft, unavailable, or a combination thereof, wherein a hard PRB is always available, a soft PRB is conditionally available, and an unavailable PRB is never available for a second communication by the IAB-DU; and
send, to a network node, via an Xn interface, an information element (IE) comprising the first information, the second information, or a combination thereof in association with the IAB-DU.

17. A processor for wireless communication, comprising:
at least one controller coupled with at least one memory and configured to cause the processor to:
receive a first configuration of a first reference signal;
receive a second configuration of a second reference signal;
receive a third configuration comprising a first indication of a set of flexible resources, a first association with the first reference signal, and a second association with the second reference signal;
determine whether a resource in the set of flexible resources is to be used for a downlink communication, an uplink communication, or a combination thereof;
in response to determining that the resource in the set of flexible resources is to be used for the downlink communication, transmit the first reference signal according to the first configuration; and
in response to determining that the resource in the set of flexible resources will be used for the uplink communication, transmit the second reference signal according to the second configuration.

18. The processor of claim 17, wherein the at least one controller is configured to cause the processor to select a first frequency range for the first reference signal based on a second frequency range of the downlink communication.

19. The processor of claim 17, wherein:
the at least one controller is configured to cause the processor to select a first frequency range for the first reference signal based on a second frequency range of the downlink communication; and
the at least one controller is configured to cause the processor to select a third frequency range for the second reference signal based on a fourth frequency range of the uplink communication, wherein a first overlap of the first frequency range and the third frequency range indicates a second overlap of the second frequency range and the fourth frequency range.

20. The processor of claim 17, wherein the first reference signal and the second reference signal are transmitted using the same frequency resources and different time resources.

21. The processor of claim 17, wherein the first reference signal and the second reference signal are transmitted using different frequency resources and different time resources.

22. The processor of claim 17, wherein the first reference signal and the second reference signal are transmitted using different frequency resources and the same time resources.
